(19) United States
(12) Patent Application Publication
(10) Pub. No.: US 2019/0184561 A1
(43) Pub. Date: Jun. 20, 2019

(54) Machine Learning based Fixed-Time Optimal Path Generation

(71) Applicant: THE REGENTS OF THE UNIVERSITY OF CALIFORNIA, Oakland, CA (US)

(72) Inventors: Michael YIP, La Jolla, CA (US); Mayur BENCY, La Jolla, CA (US); Ahmed QURESHI, La Jolla, CA (US)

(21) Appl. No.: 16/222,706

(22) Filed: Dec. 17, 2018

Related U.S. Application Data
(60) Provisional application No. 62/599,437, filed on Dec. 15, 2017.

(51) Int. Cl. B25J 9/16; G06N 5/04; G06N 3/08

(52) U.S. Cl. CPC B25J 9/1666; G06N 3/084; G06N 5/046; B25J 9/163

(57) ABSTRACT

Systems and methods are provided that introduce an improved way of producing fast and optimal motion plans by using Recurrent Neural Networks (RNN) to determine end-to-end trajectories in an iterative manner. By using an RNN in this way and offloading expensive computation towards offline learning, a network is developed that implicitly generates optimal motion plans with minimal loss in performance in a compact form. This method generates near optimal paths in a single, iterative, end-to-end roll-out that that has effectively fixed-time execution regardless of the configuration space complexity. Thus, the method results in fast, consistent, and optimal trajectories that outperform popular motion planning strategies in generating motion plans.

### CROSS-REFERENCE TO RELATED APPLICATIONS

This application claims benefit of priority of U.S. Provisional Patent Application Ser. No. 62/599,437, filed Dec. 15, 2017, entitled “MACHINE LEARNING BASED FIXED-TIME OPTIMAL PATH GENERATION”, owned by the assignee of the present application and herein incorporated by reference in its entirety.

### FIELD

The invention relates to the field of motion planning for robotics.

### BACKGROUND

Quick and accurate motion planning is critical to robotic systems. Such generally involves a robot automatically figuring out how to move between two locations while avoiding obstacles or invalid regions in its path. From “The Piano Movers Problem” of figuring out the best way to move a piece of furniture through narrow corridors, to creating artificial intelligence based on-the-fly motion plans for quadcopters, the field of motion planning has been found to be broadly useful beyond robotics and automation in such fields as virtual prototyping and computational biology. A range of techniques to solve motion planning problems have been proposed in the past two decades that emphasize optimality (exemplified by techniques such as A*) over computational expense, to those that emphasize computational speed (exemplified by techniques such as Rapidly-exploring Random Tree star (RRT*) with optimality.

The challenge of creating and optimizing motion plans using neural networks have also been of interest and have recently risen in popularity among researchers. Some early work has specified obstacles into topologically ordered neural maps and these subsequently use neural activity gradients to trace the shortest path, with neural activity evolving to a state corresponding to a minimum of a Lyapunov function. More recently, reinforcement learning (RL) has been proposed to solve for optimal policies, which in turn generate optimal motion plans. RL-based methods work by enabling a robot to explore its environment through trial-and-error and eventually optimize a long-term sum of rewards, which is usually a function of the robot's states and available actions. These often work with the assumption that the feedback necessary for the system is part of the environment in which it operates and is included in the agent's experience of the environment. This translates poorly in practice, however, and the developer usually has to hand-craft the reward function to suit the application.

Since crafting effective reward functions for complex multi jointed robot control is nontrivial and often difficult to do in practice, Learning from Demonstration (LfD) was proposed as an alternative. Using an expert (usually human) to provide demonstrations of desired trajectories, the network derives a policy that reproduces the demonstrated behavior using standard, efficient supervised learning methods. This method of developing control policies has been successfully applied in various situations. However, human demonstrations are rarely perfect, and the same task can often be done slightly different every time. This typically means that one must develop a way to infer intended trajectory from multiple suboptimal expert demonstrations, which complicates things further by adding its own set of heuristically determined hyper-parameters.

Another recently developed technique, Value Iteration Networks (VIN), emulates value iteration by leveraging recurrent convolutional neural networks and max-pooling. However, in addition to limitations inherited from the underlying RL framework, VIN dependency on convolutional neural networks limits its application to 2D, fixed grid-size mazes only.

Yet another recent and relevant method is the Lightning Framework, which is composed of two modules. The first module performs path planning from scratch using traditional motion planning methods. The second module maintains a lookup table which caches old paths generated by the first module. For new planning problems, the Lightning Framework retrieves the closest path, in term of start and goal positions, from a lookup table and “repairs” it using a traditional motion planner from the first module. This approach demonstrates good performance in high-dimensional spaces when compared to conventional planning methods. However, not only are lookup tables memory-inefficient, they also are incapable of generalizing to new environments where the locations of obstacles are different from the examples stored in the lookup table.

Thus, various technical problems are present with current systems and methods for robotics systems, including problems of computational expense, that the resulting path is suboptimal, the requirement of human training, which is also suboptimal, the requirement of human handcrafting of reward functions, or the use of lookup tables, which are memory inefficient.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Systems and methods according to present principles meet the needs of the above in several ways, in particular by providing a technical solution to the technical problems noted above, in particular by providing a computationally efficient and near-optimal solution to solving path generation problems in a consistent and fixed amount of time.

Systems and methods according to present principles in one implementation introduce an improved way of producing fast and optimal motion plans by using Recurrent Neural Networks (RNN) to determine end-to-end trajectories in an iterative manner. By using an RNN in this way and offloading expensive computation towards offline learning, a network is developed that implicitly generates optimal motion plans with minimal loss in performance in a compact form. This method generates near optimal paths in a single, iterative, end-to-end roll-out that that has effectively fixed-time execution regardless of the configuration space complexity. Thus, the method results in fast, consistent, and optimal trajectories that outperform popular motion planning strategies in generating motion plans.

Besides the above-noted efficient path generation, systems and methods according to present principles in another implementation further provide a finite-time neural motion planner which has been tested on both 2D and 3D simulated environments. The finite-time neural motion planner uses deep neural networks to learn from experience and plans end-to-end collision-free, continuous paths connecting a start and goal state for a robot to follow. This neural motion planning network includes an autoencoder (AE) (equivalently, just “autoencoder”) and a feedforward neural network. The AE takes the point cloud of a robot's surrounding and encodes the same into an invariant feature space. The feedforward neural network than takes the encoding from the AE, as well as the start and goal robotic configurations, and outputs a collision-free feasible path connecting the given configurations.

As will be described, this neural motion planner has been tested on multiple planning problems such as planning of a point-mass robot, rigid-body, and 7 DOF Baxter robot manipulators in various 2D and 3D environments. The results show that it is not only consistently computationally efficient in all 2D and 3D environments, but also shows remarkable generalization to completely unseen environments. The results also show that the computation time consistently remains less than 1 second, which is significantly lower than existing state-of-the-art motion planning algorithms. Furthermore, through transfer learning, the system trained in one scenario (e.g., indoor living places) can also quickly adapt to new scenarios (e.g., factory floors) with only a small amount of data.

Training may be employed on each new environment, making systems and methods according to present principles suitable for complex robots operating in largely static spaces, e.g., warehouses, shopping malls, airport terminals, and so on. Small, local perturbations may be allowable given the disclosed retraining and repair strategies that retain probabilistic optimality and completeness guarantees. Systems and methods according to present principles may be extended from the simulated environments to real robotic platforms, and may encompass applications spanning fields including autonomous driving, robotic surgery, aerial robotics, underwater robotics, humanoid robotics, and even space exploration.

In one aspect, the invention is directed towards an improved method of performing optimal motion path planning of a path that is both globally and locally controlled using machine learning employing a recurrent neural network, the method including offloading a portion of computation to off-line learning, including: conducting an initial observation period to construct a virtual environment corresponding to an actual environment in which a robot will operate, the robot having d degrees of freedom, the virtual environment associated with a configuration space, the actual environment having actual obstacles, the obstacles represented in the configuration space by respective obstacle regions; receiving an initial starting point and a goal point, the initial starting point and the goal point associated with respective vectors in the configuration space; calculating a training set, the training set including a plurality of valid paths between a plurality of test starting points and a respective plurality of test ending points, and dividing each valid path into a plurality of waypoints; and using the training set to train a RNN to generate step sequences for an optimal path between the initial starting point and the goal point, the step sequences constituting sequential waypoints from the initial starting point to the goal point, and where the generation of each step in the step sequence takes as an input both a current predicted position and further takes as an auxiliary input the goal point.

Implementations of the invention may include one or more of the following. The training set may be determined by a sample based motion planner, e.g., one selected from the group consisting of: A* path planning algorithm, Djikstra's algorithm, RRT, or PRM. The RNN may be further configured to extract patterns occurring through sequences of inputs. The step sequences may constitute sequential waypoints from the initial starting point to the goal point, and the step sequences may be configured to avoid the obstacle regions. The obstacle regions may be dynamic, and the method may further include performing a step of prediction, the prediction step predicting a future trajectory of the obstacle region. The initial starting point and the goal point may be defined as a task for the robot to perform. If a step in a sequence is generated but is inside an obstacle region, the method may further include performing a repairing strategy, where the repairing strategy includes randomly selecting a direction for a predetermined step distance away from a prior step, such that the predetermined step distance in the selected direction has a terminus not in the obstacle region, and then selecting the terminus as the location of a next step in the sequence, the next step directly following the prior step. The method may further include performing a rewiring process to potentially smooth paths by removing unnecessary nodes in the paths by evaluating if a straight trajectory connecting two nonconsecutive nodes in the path is collision free. The RNN may be configured to retain memory of step sequences calculated previously, the memory retained in an LSTM network.

In another aspect, the invention is directed towards an improved method of performing motion path planning for a robot of a path using machine learning employing a deep feedforward neural network, including: for a given workspace, performing a step of contractive autoencoding, the contractive autoencoding encoding the given workspace from a point cloud measurement, resulting in a workspace encoding; inputting into a deep feedforward neural network the workspace encoding, and further inputting into the deep feedforward neural network a start configuration and a goal configuration; and using the deep feedforward neural network to generate at least one end-to-end feasible motion trajectory for the robot to follow between the start configuration and the goal configuration.

Implementations of the invention may include one or more of the following.

The method may further include applying learnings from the deep feedforward neural network for the given workspace to performing a step of transfer learning, such that the step of transfer learning improves an application of the deep feedforward neural network to generate at least one end-to-end feasible motion trajectory for a robot to follow in a new workspace, the improvement including that the generation of the at least one end-to-end feasible motion trajectory is performed more rapidly than without the step of transfer learning from the deep feedforward neural network. The generation of the at least one end-to-end feasible motion trajectory is configured or trained to predict a robot configuration at time step t+1 given the robot configuration at time t, the goal configuration, and the workspace encoding. The method may further include training the deep feedforward neural network using RRT*, where an objective for the training is to minimize a mean squared error between a predicted state and an actual state, the actual state given by the RRT*.

Advantages of the invention may include, in certain embodiments, one or more of the following. Systems and methods according to present principles provide a scalable finite-time motion planning method that is significantly faster than prior motion planning methods such as RRT*. The systems and methods: 1) plan motions irrespective of obstacle geometry, 2) demonstrate mean execution time of about 1 second in different 2D and 3D workspaces, 3) generalize to new unseen obstacle locations, 4) adapt quickly with a small dataset to different working situations, and 5) have completeness guarantees. The systems and methods generally generate end-to-end collision-free paths irrespective of obstacle geometry.

Other advantages will be understood from the description that follows, including the figures and claims.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1A illustrates an “unfolding through time” version of the model architecture used according to present principles.

FIG. 1B is a flowchart of a method according to present principles.

FIG. 2 illustrates an example of bi-directional path generation.

FIGS. 3A-3H illustrates eight exemplary environments used in the experiments. The top row 3A-3D are the “simple” ones, numbering from the left, while the bottom ones 3E-3H are “difficult”. Each environment shows a specimen generated path (created with by directionality).

FIG. 4 illustrates an example showing all three path planning algorithms.

FIG. 5 illustrates an example plot of a successful path generation on a 3-Link robot using a method according to present principles, showing the trail of a 3-Link manipulator as it makes its way from joint configuration (π, 0, 0) to (π/2, 0, 0).

FIG. 6 illustrates a plot showing the times taken by A* and a method according to present principles for 50 trials conducted on the environment Difficult 2.

FIG. 7 illustrates a bar graph showing the mean and standard deviation of the generation times of A* and a method according to present principles when all the simple and difficult cases are averaged together. “S” indicates simple paths, and “D” indicates difficult ones.

FIG. 8 illustrates neural planning motions in a 3D cluttered environment for a fixed start and multiple goal configurations. For each start and goal pair, systems and methods disclosed here can generate multiple collision-free paths in a finite time.

FIG. 9 illustrates a schematic depiction of a motion planning system.

FIGS. 10-12 illustrate the offline and online phases of one implementation of a neural planning system. The bottom shaded blocks indicate the training objectives. The shaded blocks above the bottom layer represent frozen and non-frozen modules. The frozen modules do not undergo any training.

FIG. 13A illustrates an exemplary algorithm for motion planning.

FIG. 13B illustrates an exemplary algorithm for neural planning.

FIG. 13C illustrates a flowchart of a method according to present principles.

FIG. 14 illustrates an exemplary algorithm for a step of replanning.

FIGS. 15A and 15B illustrate a method according to present principles and RRT* planning paths in simple 2D environments (s2D).

FIGS. 16A and 16B illustrate a method according to present principles and RRT* planning motions in complex 2D environments (c2D).

FIGS. 17A and 17B illustrate a method according to present principles and RRT* planning paths in complex 3D environments (c3D).

FIGS. 18A and 18B illustrate rigid body motion planning by a method according to present principles and RRT* in 2D environments (rigid).

FIGS. 19A and 19B illustrate a computational time comparison of a method according to present principles and RRT* on test datasets. The plots show a method according to present principles is more consistent and faster than RRT* in all test cases.

FIG. 20 illustrates a method according to present principles planning motions for a dual-arm 7 DOF Baxter robot.

FIGS. 21A-21C illustrate example plots of successful paths generated on 3-link, 4-link, and 6-link robots using systems and methods according to present principles.

FIG. 22 illustrates transferring skills of a method according to present principles from simple 2D workspaces to complex 2D workspaces. The plot shows deeper networks (e.g., 12-layers) transfer better to new environments as the dataset size increases.

Like reference numerals refer to like elements throughout. Elements are not to scale unless otherwise noted.

### DETAILED DESCRIPTION

In a first implementation, systems and methods are provided that solve for fast, optimal motion plans using RNNs. The systems and methods take advantage of RNN's capability of generating step sequences for learning, and generate sequential waypoints from a given start position to the given goal position. The RNN may be trained on optimal trajectories that span the entire configuration space, which allows it to internalize a network that generates optimal path sequences. The training set may be created using known motion planning algorithms.

The systems and methods according to present principles provide: (1) a motion planning strategy that may take significant time to train offline, but can generate extremely fast and optimal paths online, and (2) presents consistent performance regardless of the configuration space complexity, unlike many popular online motion planners. Without wishing to be bound by theory, this is believed to be largely due to the invariance of the network to configuration space complexity, resulting in consistent (i.e., fixed-time) execution. The results of such a motion planning algorithm are demonstrated using a point robot operating in a 2D space and a 3-link robot, with the observation that the entire path connecting the queried start and goal positions is generated almost instantaneously, irrespective of where they are located. This framework can then be used to implement a wider set of RNN-based motion planners, which work beyond fixed environments and which may be learned rapidly.

RNNs have already been used successfully in certain domains, such as time series classification and machine translation. Traditionally, neural networks operate under the assumption that inputs are independent of each other. The fact that RNNs have the ability to retain memory of information previously calculated, and extract patterns occurring through sequences of inputs, suggests that incorporating memory into planning trajectories might be useful. Any finite time trajectory of a given n-dimensional dynamical system can be approximately realized by the internal state of the output units of a continuous time RNN with n output units, some hidden units, and an appropriate initial condition.

In obstacle avoidance, the network analyses the trajectory of moving obstacles and makes predictions on where the obstacle is going to be next. This is useful, e.g., in autonomous driving applications, where the system can track nearby pedestrians for a few timesteps and make predictions on their future actions, thereby enabling the system to anticipate and avoid pedestrians in its way. A theme common to these applications is that RNNs observe a certain time-length of trajectory points and make predictions for the next point in that trajectory. The overall trajectory need not head towards a specified goal. In other words, a global view of where the trajectory is heading is less important than what the local behavior is, immediately after the initial observation period elapses. Systems and methods according to present principles exploit this by generating a path that is globally and locally controlled.

A standard definition of configuration spaces (c-spaces) is used to construct the environment in which the motion planning algorithm operates. For a robot with a total of d motion DOF, the configuration space represents each DOF as a dimension in its coordinate system. Each d-dimensional point in the c-space represents all the joint values of the robot and therefore, the configuration of the robot in the real world. Due to this property, motion planning in c-spaces is generally simpler than in geometric spaces, as the motion planning task involves connecting two points in a d-dimensional constrained space. Obstacles in geometric space often transform into unrelated shapes in c-space, and thus require additional computation to determine which points in the c-space are in collision with obstacles. One algorithm that may be employed for collision detection is GJK, and the same is one one exemplary method to determine if a given point in c-space is in an obstacle region or not. Other collision detection schemes, methods, and systems, may be used. The determined configuration space defines a particular robot present in a static constrained workspace environment.

The configuration space and relevant parameters may be defined in one implementation as follows. X=(0, 1)^{d} is the c-space. X_{obs} is the obstacle region, such that X\X_{obs} is an open set, and the obstacle-free space is denoted as X_{free}=cl(X\x_{obs}), where cl( ) denotes the closure of a set. The initial start point Xᵢₙᵢₜ and the goal point x_{goal}, also termed initial start and goal configurations, both elements of X_{free}, are provided as query points. One exemplary objective is to find a path between xᵢₙᵢₜ and x_{goal} in the c-space. x may be defined as a discrete sequence of waypoints. x is considered valid if it is continuous, collision free (each waypoint in the generated path should lie in X_{free}), and feasible (x(0)=xᵢₙᵢₜ, X(t)=x_{goal} for some finite t).

One exemplary algorithm, implementable by a system and method according to present principles, solves the problem of generating goal=oriented path sequences by passing in the goal location as an auxiliary input at each step of the prediction. The idea behind using an auxiliary input in this way is to provide a reminder to the network about where it should ultimately converge. At each sequence step, the input vector is concatenated with an auxiliary input vector and the resulting “enhanced” input vector is used to train an otherwise standard RNN model. Additionally, Long Short Term Memory (LSTM) networks may be employed, where a special activation function may be employed used to preserve information over long memory chain, overcoming the issue of vanishing gradients in vanilla RNN when the required memory length is more than a few steps, decreasing its memory capacity. In one implementation, fixed short term memory was used; experiments showed that using LSTMs resulted in better performance over vanilla RNNs, even though training LSTMs are usually more difficult.

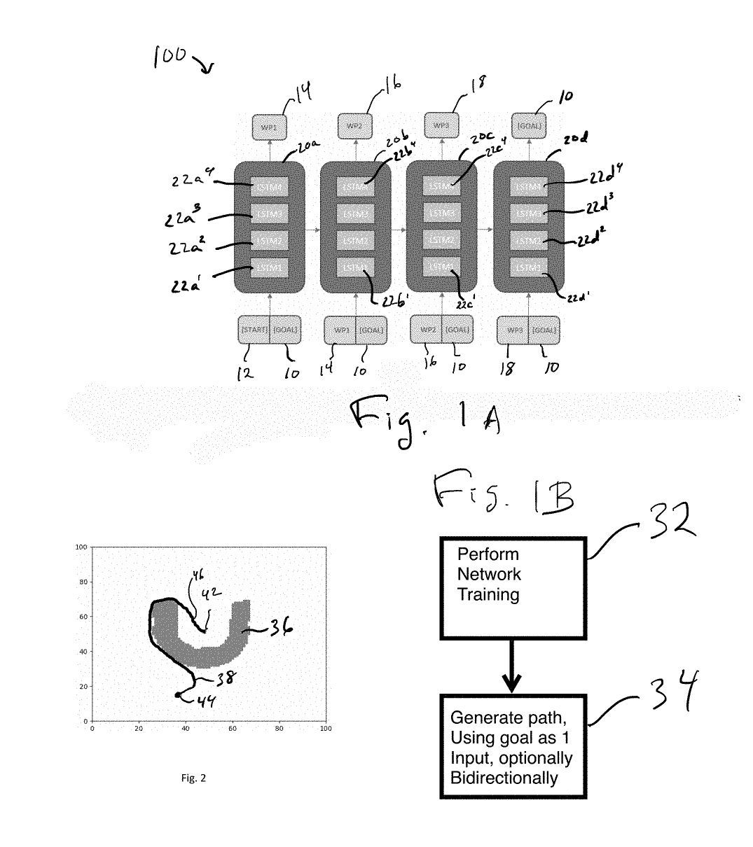

FIG. 1B illustrates a flowchart showing the basic steps of a method according to present principles. Each of these steps will be described in greater detail below. In a first step, a network is trained (step 32). In the next step, a path is generated using the network as trained, and in some cases this path may be generated bidirectionally (step 34).

Since the network training is supervised in nature, a training set is provided including a number of valid paths created by an “expert” planner. These may be created in a known fashion, e.g., using the A* path- planning algorithm to generate the training set due to its speed and path optimality. However, other path planning algorithms may be used.

The c-space is sampled to create a graph with connected nodes. Two nodes are randomly selected without replacement (based on a uniform distribution) from a set of nodes present in X_{free}, and A* is executed to find the optimal path connecting them. This process is repeated N times to obtain a training set consisting of N expert paths.

In the path planning method, the network is trained to take in one waypoint and output the next waypoint in the sequence, so the training set has to be designed accordingly. Each A* generated path in the set is split into their composing waypoints to make each individual waypoint represent a sample in the training set. A teaching signal corresponding to each sample then becomes the next waypoint in the path sequence. That is, if x is a path with t waypoints, the path is split into x(0), x(1), . . . , x(t−1), and the corresponding teaching signals become x(1), x(2), . . . , x(t). If it is assumed that x(t) is the goal point in a sequence, then the auxiliary input is concatenated as x^{˜}(k)=[x(k), x(t)], where k ranges from 0 to t. Since each x(k) is a point in the d-dimensional c-space, x^{˜}(k) has dimensionality 2d. Thus, the input of the network becomes a M×2d matrix, where M is the number of samples obtained after the N paths are split as described above. The teaching signal is similarly M×d.

In one implementation of present systems and methods, shown in FIG. 1A by the network architecture 100, the system is seen to be composed of 4 stacked LSTM layers 22a₁-22a₄, each with 256 memory units, with the output layer being connected to the final LSTM hidden layer. In particular, FIG. 1A illustrates an “unfolded through time” version of the model architecture. The hidden layer weights are shared across timesteps as the inputs are iteratively updated and concatenated. When a start configuration 12 and a goal configuration 10 are input into the RNN 20a, the output is the first waypoint 14. The first waypoint 14 is concatenated with the goal configuration 10 as the network evolves to 20b with LSTM layers 22b₁-22b₄. This continues for subsequent waypoints such as waypoints 16 and 18, as the network unfolds through time, shown by states 20c and 20d with corresponding respective LSTM states.

The number of layers was determined empirically, based on rate of convergence and overall success rates, by empirically converging to an appropriate size based on the dimensionality of the problem to be solved. Increasing the number of layers as the dimension of the configuration space is increased, to capture additional degrees of freedom in the training set, can lead to better performance. For any finite time trajectory of a given n-dimensional dynamical system, a practical limit in expanding network size can be approximately realized by the internal state of the output units of a continuous time RNN with n output units, some hidden units, and an appropriate initial condition.

Although the advantages of depth in RNNs are not as straightforward as in a feedforward neural network, which is a tape discussed in an alternative implementation, there is evidence that stacking RNN layers do outperform shallow ones when a more immediate input and output process is to be modeled.

The training procedure is now described. The error signal on which training occurs is the mean square error (MSE) between the predicted output and the teaching signal. Traditionally in LfD methods, the output is sampled from a probability distribution, which is typically parameterized by the output units of the neural network used. This is done in anticipation of irregularities in the training set. Since the training set here is typically generated by human beings, there are significant variations within the demonstration cases even for the same tasks.

To capture these irregularities and avoid excessive averaging between training samples of the same task, multi-modal distributions are used to emulate the training data; a simple MSE is generally not enough. In the present case, however, A* ensures that each combination of input and output has exactly one unique path connecting them, hence the question of excessive averaging does not arise when using MSE and thus, using a deterministic model for the output is justified. After the network training converged to a satisfactory degree, two points were selected, yᵢₙᵢₜ and y_{goal} (not from the training set) from X_{free}, and an attempt was made to determine or “rollout” a path connecting them while avoiding obstacles. Similar to the training procedure, yᵢₙᵢₜ and y_{goal} were concatenated and passed as an input for the next prediction. After passing through the network, the generated output was added as a waypoint, concatenated with y_{goal}, and looped back into the prediction input. This procedure was continued until the current waypoint was within a predetermined distance of y_{goal} in the c-space. After the process terminated, all the sequentially generated outputs are formatted as waypoints in the generated path.

To make the path generating process more robust, a bidirectional path generation was employed in one embodiment. Note that this procedure is not to be confused with bidirectional RNNs. In a bidirectional path generation, the generation process is started from the initial starting point and the goal point simultaneously, and the two branches are caused to grow towards each other. The process is terminated when the two branches meet, or their endpoints come within a predetermined distance from each other, and the branches are then joined or stitched together to form a complete path. This ensures that both start and end locations are anchored, with the motion plan generated effectively starting and ending at the desired location.

FIG. 2 is an example of how this bidirectional path generation process works. The marker 44 and the marker 42 are the start and the goal respectively. The path 38 grows (equivalently, generated) from the start marker 44, while simultaneously, the path 46 grows (or is generated) from the goal marker 42. The process is terminated when the heads of the paths get within a set distance of each other.

Compared to unidirectional path generation, a bidirectional path generator allows sequences to meet in the middle of the RNN-generated path, which has a higher chance of convergence than a unidirectional path generator, where the sequence needs to converge to an arbitrary position that was not an output from an RNN. Put another way, instead of forcing the path to “grow” towards an arbitrarily-selected fixed goal point, the network in bidirectional path generation has the option to target a constantly shifting goal point (the current point of the other branch). This increases the chance of the convergence point coinciding with the paths on which the network was trained, thus increasing feasibility and success rates, while having little or no impact on path rollout time It was confirmed experimentally that bidirectional path generation has no significant impact on path optimality or rollout time.

To appropriately evaluate the performance and capability, systems and methods according to present principles, the same were tested on a number of distinct environments. The experiments were conducted in a 2D “gridworld” with a point robot having translation capabilities only, with extensions being performed on a 3-link planar manipulator as well.

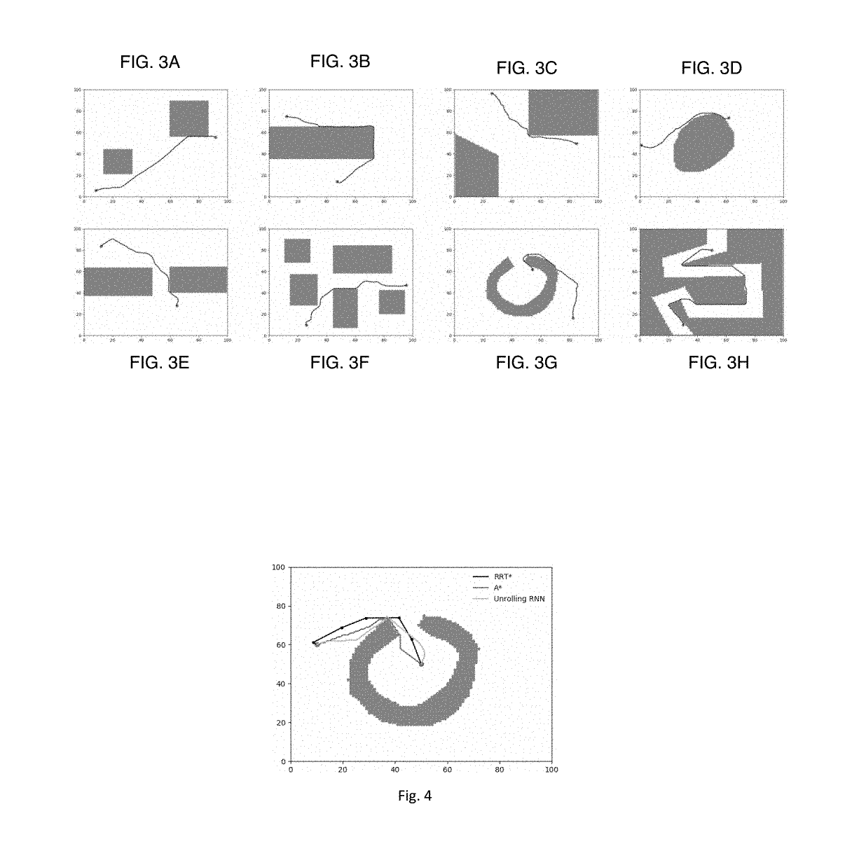

Referring to FIG. 3A-3H, the algorithm was tested on eight different environments for the 2D gridworld case, from “simple” and “difficult” environments. Each environment also is shown with a path generated by an embodiment of the systems and methods according to present principles.

An environment was considered simple if the obstacles are convex and widely spaced (3A-3D), while difficult environments consist of either a large number of obstacles or highly non-convex obstacles forming narrow passageways (3E-3H). Each continuous space environment was 100 units in length and breadth. To run A* and generate the training set, a uniform grid with each node spaced at a distance of 1 unit from each other was overlaid on the environment. Since GJK is not required to perform collision checking in gridworld problems, a simple conditional statement for polygonal regions suffices.

For each environment, the training set was created each having 20,000 valid paths, in the manner described above. After performing the required processing, the total size of the training set expanded to nearly 1 million data points, with each environment having a slightly different total. This set was split in accordance to the 80-20 rule, with 20% being kept for testing to make sure overfitting did not occur. As shown in FIG. 1A, 4 LSTM layers were stacked on top of each other for better non-linear modelling, and the model was trained using backpropagation (i.e., a standard neural network training method), and adadelta with default parameters was used as an optimizer. Adadelta is one choice of several training strategies that are often provided with software packages like Tensorflow®.

All the environments were trained on identical network configurations. Training was accomplished with Tensorflow and Keras, a high-level neural network Python library, with a single NVIDIA Titan Xp used for GPU acceleration. Due to the similarity in model architectures and dataset sizes, all eight cases took roughly the same amount of time to converge, i.e., 5.5 hours, on average, with MSE being used as the loss metric to measure convergence. This constituted the online learning step.

To benchmark the performance of the algorithm according to present principles with existing motion planning algorithms, the same was compared with RRT* and A*. RRT* is a version of RRT, where heuristic cost is added to encourage optimality of the path in a sampling-based continuous space.

Three performance metrics were employed: success rate, roll-out time, and path optimality. A generated path was considered successful if none of the waypoints encroached into the obstacle region. FIG. 4 illustrates the results, showing all three path planning algorithms. The times taken to generate the paths were 0.48 s, 13.27 s, and 0.16 s for A*, RRT*, and an implementation of a method according to present principles, respectively.

Roll-out time measures the time taken for the network to generate waypoints from start to goal (or, in the bidirectional case, time taken for both branches to meet). Path optimality is the total length of the path.

50 randomly initialized trials were conducted for each of the eight environments and the results are shown in Table I.

TABLE I
PERFORMANCE OF RNN-BASED MOTION PLANNER COMPARED TO A* AND RRT*

| Environment | Success Rate | A* (s) | RRT* (s) | Unroll RNN (s) | A*/Unroll RNN | RRT*/Unroll RNN |
|---|---|---|---|---|---|---|
| Simple 1 | 94% | 0.33 (0.27) | 33.86 (21.65) | 0.13 (0.06) | 0.95 (0.06) | 0.99 (0.1) |
| Simple 2 | 96% | 0.91 (0.99) | 20.64 (15.44) | 0.2394 (0.17) | 0.91 (0.09) | 0.93 (0.12) |
| Simple 3 | 96% | 0.56 (0.55) | 13.04 (15.18) | 0.16 (0.11) | 0.94 (0.05) | 0.97 (0.16) |
| Simple 4 | 100% | 0.36 (0.32) | 1.29 (0.43) | 0.23 (0.11) | 0.98 (0.05) | 1.00 (0.10) |
| Difficult 1 | 96% | 0.72 (0.56) | 21.84 (16.54) | 0.23 (0.10) | 0.89 (0.08) | 0.92 (0.10) |
| Difficult 2 | 96% | 0.61 (0.58) | 16.44 (9.17) | 0.19 (0.11) | 0.95 (0.06) | 1.01 (0.17) |
| Difficult 3 | 98% | 0.40 (0.39) | 38.52 (29.57) | 0.21 (0.12) | 0.97 (0.04) | 0.98 (0.11) |
| Difficult 4 | 98% | 1.29 (1.37) | 12.79 (18.81) | 0.18 (0.12) | 0.95 (0.14) | 0.91 (0.21) |

Values are listed as “mean (standard deviation)” for 8 different environments.

The third through fifth columns show mean and standard deviation of the times taken for each environment, while the last two columns show the mean and standard deviation of the fraction of the path length generated by an implementation of the present algorithm (“unroll RNN) when A* and RRT* were respectively considered as optimal.

To determine the extensibility of the algorithm according to present principles to higher dimensions, and to see how it would work in real world scenarios, it was also tested on 3-Link manipulators. In this case, to train the RNN, the c-space was randomly sampled 1 million times to populate the nodes on the A* graph, using GJK to sort them into free and obstacle regions accordingly. 20,000 example paths were initially provided in the training set and the same steps were followed as described above for the 2D case. Keeping in mind the increased number of dimensions to learn, the architecture was updated to have 300 memory units per layer, keeping the rest of the parameters the same. The network was trained as per the procedure described in the previous sections. It was observed that the network showed a strong tendency to generate valid paths, with FIG. 5 being one such example, a successful path generation on a 3-Link robot using an algorithm according to present principles, showing the trail of a 3-Link manipulator as it makes its way from joint configuration (π, 0, 0) to (π/2, 0, 0). The robot was designed and plotted using Peter Corke's Robotics Toolbox for MATLAB.

Systems and methods according to present principles were also tested on 4-link and 6-link manipulators. The base link has movement range zero to a while the subsequent links can move between −π to π For the 3-link manipulator, the three-dimensional joint angle configuration space was discretized into a 3D uniform grid with 50 nodes on each axis, resulting in a total of 50³=125,000 uniformly spaced nodes. For the 4-link and 6-link cases, the corresponding n-dimensional configuration space was discretized into 40 and 10 uniformly spaced nodes per axis, respectively. As in the 2D case, A* was used to generate the training set.

To get an accurate representation of the complete c-space in the training set (which directly correlates to the increased number of nodes in the grid used for training), 400,000 were used for the 3-link case, and 1 million each for the 4-link and 6-link cases. Due to the increased number of dimensions to learn, the architecture was updated to have six layers with 256 units each for the 3-link case, and six layers with 400 units each for both 4-link and 6-link cases.

To evaluate performance, 1000 pairs of start and goal locations in continuous c-space were randomly generated. Paired with the repair and rewire modules discussed elsewhere, a 100% success rate was observed in finding feasible paths. Generation times and path optimality was benchmarked against A* and RRT*, and it was seen that systems and methods according to present principles performed significantly better than prior art pathfinding algorithms. In addition, path generation times according to present systems and methods had low standard deviations, indicative of the consistency in producing paths across the entire c-space, while prior art methods such as A* and RRT* are significantly influenced by the relative locations of the query points in the obstacles.

As additional tests, 100 successful randomly initialized trials were conducted and the average path unrolling time was 0.38 seconds with a standard deviation of 0.18, thereby showing that unrolling of paths using algorithms according to present principles is substantially invariant to the dimensionality of the problem. Note that the start and goal configurations are not present in the training set. Making sure that the training set represents all regions of the c-space is key to a consistent and successful path generation. Thus, with a larger network and dataset, it is believed that the rapid and optimal motion planning demonstrated in the 2D case can be replicated in higher dimensions.

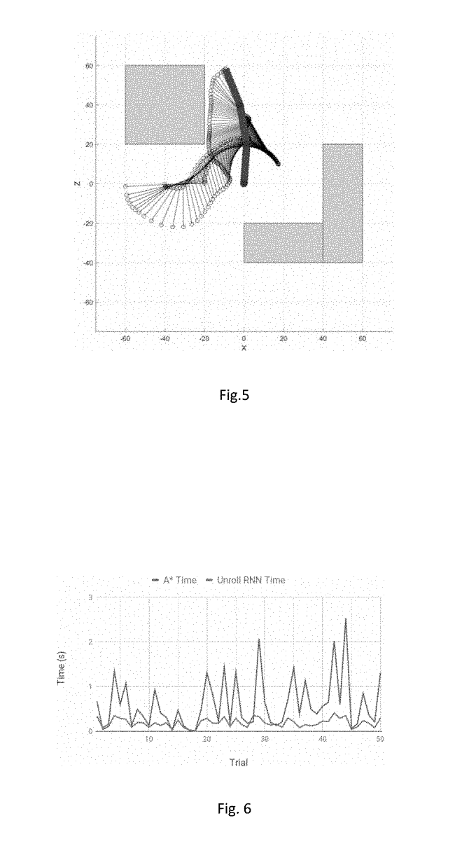

FIG. 6 shows the path generation time for A* and an exemplary method according to present principles across 50 trials conducted for the environment Difficult 2. The plot for RRT* is not shown for clarity. From the figure, it is seen that the method according to present principles is faster or at the very least comparable to A* in most trials, and advantageously, the time taken for path generation is far more consistent. Path planning in A* takes very little time when there is a direct line of sight between start and goal, but is significantly longer with complexity in obstacle, and the sames; this causes the large variation seen in FIG. 6. On the other hand, path generation in methods according to present principles, being sequential and taking roughly the same amount of time to output each waypoint, is mostly linear with the distance between the start and the goal. Further, since during prediction the network is simply feedforward, i.e., the network feeds the input data forward through its layers to the output in a repeatable manner, it takes very little time to output each waypoint, resulting in fixed-time execution for each next optimal step. This makes the process far more consistent, no matter where the start and the goal are located in the environment.

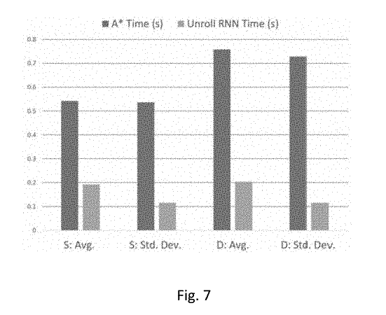

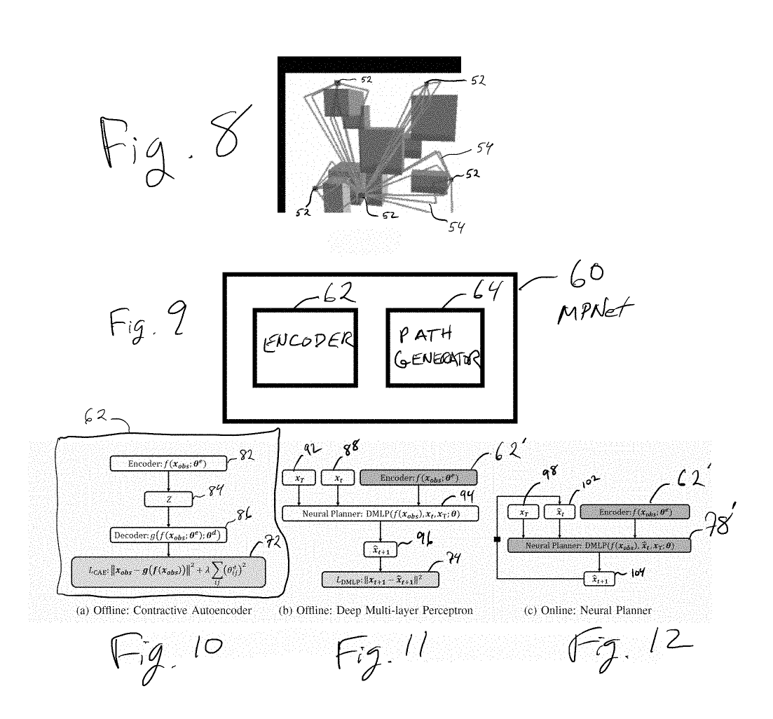

FIG. 7 is a broader analysis of this data, with all the simple and difficult cases averaged together respectively to observe how complexity of the environment affects results. In particular, the figure shows a bar graph indicating the mean and standard deviation of the generation times of A* and a method according to present principles when all the simple and difficult cases are averaged together, where S indicates simple and D indicates difficult.

On average, there is an approximately 25% jump in both mean and standard deviation of path generation time when moving from simple environments to difficult ones for A*. However, there is hardly any change in these metrics for methods according to present principles, thus confirming its high degree of invariance to the complexity of the environment. As for path optimality, the last two columns of Table I show how algorithms according to present principles compare with A* and RRT*. It is clear that on average, the paths generated by present systems and methods are very close in optimality to A* and RRT*, irrespective of the type of environment used. Without wishing to be bound by theory, it is believed that the reason for this is related to the way the network is designed, as the same attempts to emulate what it has seen in the data set and attempts to generalize based on that. Since the data set corresponds to A*, which itself is generally optimal, the paths unrolled by the algorithm tend to be close to optimal as well.

The speed and invariance to environments does come at a cost, namely the creation of a dataset, and time and computation power required to accurately generate paths. This cost is easier to accept if the algorithm is viewed as an extremely fast way to create online motion plans in any given environment, with the assumption that the process of training the network occurs offline and thus such training time does not impact motion planning itself. This also means that the algorithm is generally optimized for the case where the environment is static, as even relatively minor changes in the environment would be unknown to the network when generating the paths. However, it will be understood that strategies may be employed to adapt the algorithm to dynamic environments with minimal time spent in training and retraining models. Such may include rapidly updating the weights of the network to reflect changes in the environment. One of the most important advantages is the fact that a neural network is able to sequentially generate a path between any given start and goal with the only hyper-parameters being the network layers and hidden units, where hyper-parameters are the tunable parameters that define the size, width, and activation functions of the neural network. Neural networks are highly versatile and significant improvements in accuracies can be observed just by modifying certain such hyper-parameters. Thus the network described here is easily tunable. It is further believed that the average path unrolling time can be reduced even further by designing a leaner network (i.e., a smaller neural network with fewer hyper-parameters), where similar improvements would involve redesigning the entire algorithm for conventional motion planning algorithms.

In another embodiment, a finite-time neural motion planner is disclosed that uses deep neural networks to learn from experience such that the same is capable of planning end-to-end collision-free, continuous paths connecting a start and goal state for a robot to follow. This neural motion planning network is termed herein “MPNet”. FIG. 8 illustrates MPNet planning motions in a 3D cluttered environment for a fixed start and multiple goal configurations (shown as boxes 52). For each start and goal pair, MPNet can generate multiple collision-free paths, shown as lines 54, in a finite time.

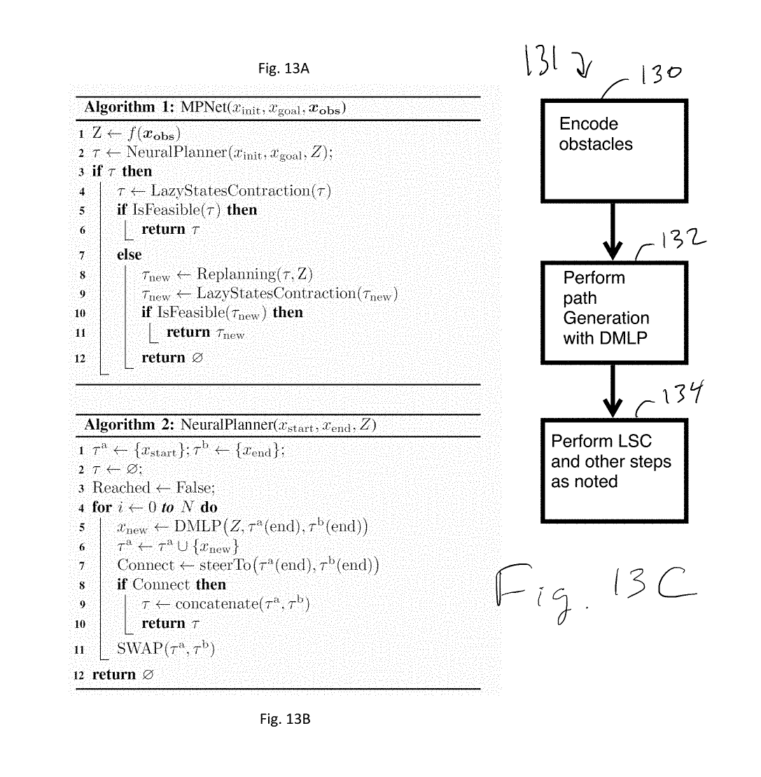

Referring to FIG. 9, an exemplary implementation of a system architecture of MPNet 60 includes at least the following two components: an obstacle-space encoder 62 and a path generator 64.

In one implementation, the obstacle space encoder 62 is provided by an contractive autoencoder (AE), which may be a contractive autoencoder in one embodiment, and the same is employed to encode a point cloud of the obstacles into a latent space. The path generator 64 is a deep feed-forward neural network which is trained to predict the robot configuration at time step t+1 given the robot configuration at time t, the goal configuration, and the latent-space encoding of the obstacle space. Once trained, MPNet can be used in conjunction with a bi-directional iterative algorithm to generate feasible trajectories, in a manner disclosed above and below.

While these components are described in greater detail below, FIG. 10-12 illustrate the off-line and online components or phases of the MPNet 60. The off-line phases include the autoencoder (FIG. 10) and a deep multilayer perceptron (DMLP) (FIG. 11). The online components include a neural planner (FIG. 12). In FIGS. 10-12, elements 72 and 74 indicate training objectives. Elements 62′ and 78′ indicate frozen modules, which are modules that do not undergo training in their respective phases. The remaining blocks, i.e., the clear or white blocks, represent non-frozen modules, and these do undergo training in their respective phases.

Validation of the model occurred by testing on a large dataset of complex, cluttered 2D and 3D environments. To highlight the computational robustness of systems and methods according to present principles, the same were also tested on a rigid body motion planning problem. As neural networks do not provide theoretical guarantees on their performance, a hybrid algorithm was proposed which combines MPNet with any existing classical planning algorithm, e.g., RRT*, and the same demonstrated a 100% success rate consistently over all tested environments while retaining computational gains.

The attained results indicated that MPNet generalizes very well, not only to unseen start and goal configurations within workspaces, which were used in training, but also to new workspaces which the algorithm has never seen. Furthermore, it is shown that MPNet can utilize transfer learning to adapt a model trained on one type of environment to an entirely different environment with just a small amount of data. The code for MPNet is available online including the training and testing dataset at https://sites.google.com/view/mpnet/home, and this material is incorporated by reference herein in its entirety.

The below section is analogous to that described above and defines notations used here as well as formally defining the motion planning problems addressed by systems and methods according to present principles.

Let q be an ordered list of length N€ [symbol] , then a sequence {qᵢ=Q(i)}_{i€N} is a mapping from i€ [symbol] to the i-th element of Q. Moreover, for the algorithms described in this paper, Q(end) and Q.length( ) give the last element and the number of elements in a set Q, respectively. Let X⊂ [symbol] ^{d} be a given state space, where d€ [symbol] _{>=} [symbol] _{is the dimensionality of the state space. The obstacle and obstacle-free state spaces are defined as X}_{obs}⊂X and X_{free}=X\X_{obs}, respectively. Let the initial state be xᵢₙᵢₜ€X_{free}, and the goal region be X_{goal}⊂X_{free}. Let an ordered list τ be a path having non-negative and nonzero scalar length. A solution path T to the motion planning problem is feasible if it connects xᵢₙᵢₜ and x€X_{goal}, i.e., τ(0)=xᵢₙᵢₜ and τ(end)€X_{goal}, and if the path lies entirely in the obstacle-free space X_{free}.

Systems and methods described here address the feasibility problem of motion planning i.e., given a triplet {X,X_{free},X_{obs}}, an initial state xᵢₙᵢₜ and a goal region X_{goal}⊂X_{free}, the desire is to find a path solution τ€X_{free} such that τ(0)=xᵢₙᵢₜ and τ(end) €X_{goal}.

Systems and methods according to present principles are now described in greater detail. MPNet in one implementation is a neural network based motion planner comprised of two phases, which is analogous in some ways to the flowchart shown in FIG. 1B. The first phase corresponds to offline training of the neural models. The second corresponds to the online path generation.

### Offline Training

As noted, in one implementation systems and methods according to present principles use two neural models to solve the motion planning problem. The first model is an autoencoder (AE) which embeds the obstacle point cloud, corresponding to a point cloud representing X_{obs}, into a latent space (see, e.g., FIG. 10). The second model is a feed-forward deep neural network which learns to do motion planning for the given obstacle embedding from the AE, as well as the start and goal configurations (see FIG. 11).

Autoencoder: the autoencoder is used to embed obstacles as a point cloud into an invariant and robust feature space Z € m, where m € N is the dimensionality of the feature space. Let f(x_{obs}; θ^{e}) be an encoding function, used in step 82, parameterized by θ^{e}, which encodes the input vector x_{obs}€X_{obs} into the latent space Z (element 84). A decoding function (element 86) g(f(x_{obs}); θ^{d}), with parameters θ^{d}, decodes the feature space Z:=f(x_{obs}) back to obstacle space ̂x_{obs}€X_{obs}. The objective function for the AE is given below (see also module 72):

$${L}_{CAE} ( {θ}^{ϵ} , {θ}^{d} ) = \frac{1}{{N}_{obs}} {\sum }_{x ∈ {D}_{Obs}} {‖ x - g ( f ( x ) ) ‖}^{2} + λ {\sum }_{ij} {( {θ}_{ij}^{e} )}^{2}$$

In this equation λ is a penalizing coefficient, and D_{obs} is a dataset of point clouds X_{obs}€X_{obs} from N_{obs}€ [symbol] different workspaces. The penalizing term forces the feature space f(x_{obs}) to be contractive in the neighborhood of the training data which results in invariant and robust feature learning.

Deep Multi-Layer Perceptron (DMLP): a feedforward deep neural network was used, parameterized by θ, to perform motion planning. Given the obstacle encoding Z, current state xₜ (element 88) and the goal state x_{T} (element 92), DMLP (element 94) predicts the next state ̂xₜ₊₁ (element 96) €X_{free} which would lead a robot closer to the goal region, i.e.:

\hat{x}ₜ₊₁=DMLP((xₜ,x_{T},Z);θ)

To train DMLP, RRT* was used to generate feasible, near-optimal paths in various environments. The paths given by RRT* are a tuple, τ*={x₀, x₁, . . . , x_{T}}, of feasible states that connect the start and goal configurations so that the connected path lies entirely in X_{free}. The training objective for the DMLP is to minimize the mean-squared-error (MSE) loss between the predicted states ̂xₜ₊₁ and the actual states xₜ₊₁ given by the RRT*. The training loss for the DMLP is in one implementation given as follows:

$${L}_{mlp} ( θ ) = \frac{1}{{N}_{p}} {\sum }_{j}^{\hat{N}} {\sum }_{i = 0}^{T - 1} {‖ {\hat{x}}_{j , i + 1} - {x}_{j , i + 1} ‖}^{2}$$

(Element 74) where Nₚ€ [symbol] is the averaging term corresponding to the total number of paths, ̂N€ [symbol] , in the training dataset multiplied by the path lengths.

### Online Path Planning

The online phase exploits the neural models from the offline phase to effectively perform motion planning in cluttered and complex environments. The overall flow of information between the encoder f(x_{obs}) 62′ and the DMLP 78′ is shown in FIG. 12. To generate end-to-end feasible paths connecting the start and goal states, a novel incremental bidirectional path generation heuristic was used. Algorithm 1 shown in FIG. 13A illustrates the overall path generation procedure. The rest of the section describes various functions used by Algorithm 1 and the overall execution of the method according to present principles. In addition, as noted from the flowchart 131 of FIG. 13C, the steps may be summarized as encoding obstacles (step 130), performing path generation with, e.g., DMLP, (step 132), followed by performing steps of LSC (described below) as well as other steps as noted below (step 134). These are now described in greater detail.

1) Obstacles Encoder f(x_{obs}): The encoder function f(x_{obs}) 62′, trained during the offline phase, is used to encode the obstacle's point cloud x_{obs}€X_{obs} into a latent space Z€ [symbol] ^{m}.

2) DMLP: The DMLP 78′ is a feed-forward neural network from the offline phase which takes Z, the current state xₜ (element 102), the goal state x_{T} (element 98), and predicts the next state of the robot ̂xₜ₊₁ (element 104). To inculcate stochasticity into the DMLP, some of the hidden units in each hidden layer of the DMLP were dropped out with a probability p: [0, 1]€R. The merit of adding the stochasticity during the online path generation is discussed below.

3) Lazy States Contraction (LSC): Given a path τ={x₀, x₁, . . . , x_{T}}, the LSC algorithm connects the directly connectable non-consecutive states, i.e., xᵢ and x_{>i+1}, and removes the intermediate/“lazy” states. This process is also often known as smoothing or shortcutting. The term contraction is coined as it is used in graph theory literature.

4) Steering: The steerTo function takes two states as an input and checks whether a straight trajectory connecting the given two states lies entirely in collision-free space X_{free} or not. The steering is done from x₁ to x₂ in small, discrete steps and can be summarized as: τ(δ)=(1−δ) x₁+δx₂, for δ€[0, 1] is Feasible: Given a path τ={x₀, x₁, . . . , x_{T}}, this procedure checks either the end-to-end path, formed by connecting the consecutive states in τ, lies entirely in X_{free} or not. The output is a boolean which is set to TRUE if the path T is completely collision-free, and is otherwise set to FALSE.

5) Neural Planner: This is an incremental bidirectional DMLP based path generation heuristic, and one example is shown in FIG. 13B as Algorithm 2. This algorithm takes the obstacle representation, Z, as well as the start and goal states, as an input, and outputs a path connecting the two given states. The sets τₐ and τ_{b} correspond to the paths generated from the start and goal states, respectively. The algorithm starts with τₐ, and generates a new state x_{new} from the start towards the goal (Line 5), and checks if a path from the start τₐ is connectable to the path from the goal τ_{b} (Line 7). If paths are connectable, an end-to-end path T is returned by concatenating τₐ and τ_{b}. However, if paths are not connectable, the roles of τₐ and τ_{b} are swapped (Line 11) and the whole procedure is repeated again. The swap function enables the bidirectional generation of paths, i.e., if at any iteration i, path τₐ is extended, then in the next iteration i+1, path τ_{b} will be extended. This way, as described, two trajectories τₐ and τ_{b} progress towards each other which makes this path generation heuristic greedy (meaning that it steps in directions that immediately take it closer to the goal (even if the chosen route will never reach the goal, or tends to be longer than another route)) and fast.

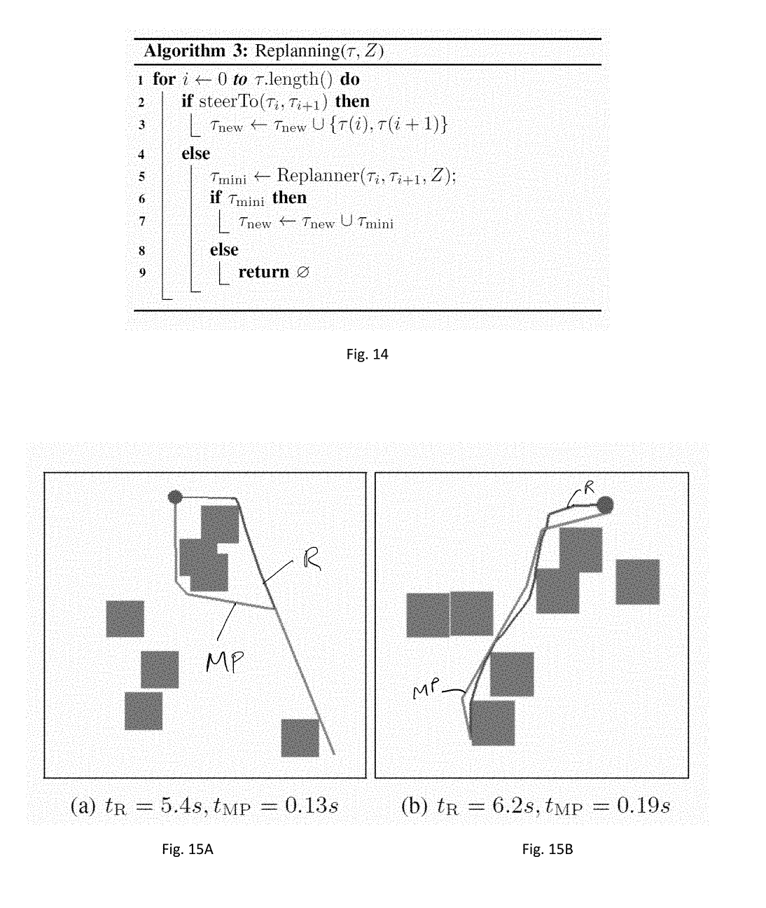

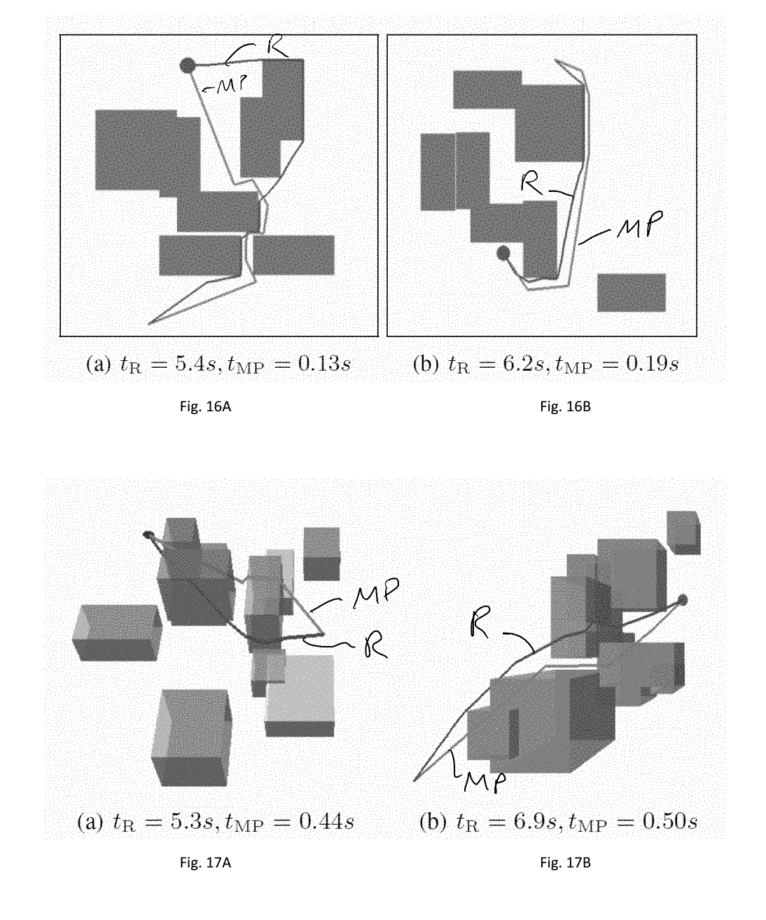

6) Replanning: This procedure is outlined in the Algorithm 3 shown in FIG. 14, and iterates over all the consecutive states xᵢ and xᵢ₊₁ in a given path τ={x₀, x₁, . . . , x_{T}}, and checks if they are connectable or not, where i=[0, T−1]⊂ [symbol] . If any consecutive states are found not connectable, a new path is generated between those states using one of the following replanning methods (Line 5).

a) Neural Replanning: Given the start and goal states together with obstacle space encoding Z, this method recursively finds a new path between the two given states. To start, a coarse path is found between the given states and then, if required, it replans on a finer level by calling itself over the non-connectable consecutive states of the new path. This recursive neural replanning is performed for a fixed number of steps to limit the algorithm within the computational bounds.

b) Hybrid Replanning: This technique combines neural replanning with one or more classical motion planning methods. It performs the neural replanning for a fixed number of steps, and the resulting new path is tested for feasibility. If the path is not feasible, the non-connectable states in the new path are then connected using a classical motion planner. In other words, it uses systems and methods according to present principles until a mistake occurs, then it falls back on other techniques, e.g., RRT*, A*, etc.

Algorithm 1 outlines the overall procedure which exploits all the aforementioned heuristics to generate the feasible end-to-end paths. It starts by finding a coarse path T connecting start and goal (Line 2). If a valid path, τ, is found, the lazy states in the path are removed (Line 4) and the feasibility tests are performed (Line 5). If a path is feasible, it is returned as a path solution. Otherwise, a replanning is done on a finer level to repair the segments of the coarse path which do not lie entirely in the obstacle-free space (Line 8). The replanning method returns a new feasible path if one exists. This new path is returned as a path solution after the step of lazy states contraction (Lines 9-11).

The neural models described, e.g., AE and DMLP, may be implemented in PyTorch (see pytorch.org). The path generation heuristic and the classical motion planner, e.g., RRT*, may be implemented in, e.g., Python. The system used for training and testing has 3.40 GHz×8 Intel Core i7 processor with 32 GB RAM and GeForce GTX 1080 GPU. The below describes different modules, which may be implemented as software blocks or, e.g., in firmware or hardware, and which are used in MPNet.

To generate different 2D and 3D workspaces, a number of quadrilateral blocks may be virtually situated within the operating region of 40×40 and 40×40×40, respectively. The positions of these blocks were randomly sampled without replacement from the operating region. Each random placement of the obstacle blocks leads to a different workspace. To generate different feasible start and goal states within each of the generated workspaces, a list of n€ [symbol] states were randomly sampled from the obstacle-free space. A pair of states from the list were selected randomly, without replacement, to form a start and goal pair. These start and goal pairs were then used to generate the feasible paths (using RRT*) for training and testing. By following the aforementioned procedure, 110 different workspaces were generated for each presented case, i.e., simple 2D (s2D), rigid-body (rigid), complex 2D (c2D), and 3D (c3D) (see next section). In each of the workspaces, 5000 collision-free paths were generated using RRT*. The training dataset included 100 workspaces with 4000 paths in each workspace. For testing, two types of test datasets were created. The first test dataset included the above described already seen 100 workspaces, with 200 “unseen” start and goal configurations in each workspace. The second test dataset included 10 completely unseen workspaces where each contained 2000 unseen start and goal configurations. In the case of the work described here with the Baxter robot (https://en.wikipedia.org/wikiBaxter_(robot)), the environment encoding was not included as only a single environment was considered. Therefore, only start and goal configurations were sampled to compute training trajectories (50,000) from the obstacle-free space to train DMLP for the robot.

### System Architecture

1) Autoencoder (AE): The encoding function f(x_{obs}) and decoding function g(f(x_{obs})) included three linear layers and one output layer, where each linear layer was followed by a Parametric Rectified Linear Unit (PReLU). Since the structure of the decoder was simply the inverse of the encoding unit, only the structure of the encoder is described.

The input to the encoder is a vector of point clouds of size 1400×d where 1400 are the points along each dimension, and d€ [symbol] >=2 is the dimension of a workspace. For 2D workspaces, the layers 1, 2 and 3 transform the input vector 1400×2 to 512, 256 and 128 hidden units, respectively. The output layer takes the 128 units as an input and outputs 28 units. Hence, the obstacle representation Z€ [symbol] ^{m} is a vector of size m=28. These 28 units are then taken by the decoder to reconstruct the 1400×2 space. For the 3D workspaces, the layers 1, 2 and 3 map the input vector 1400×3 to 786, 512, and 256 hidden units. The output layer transforms the input 256 units to output 60 units, i.e., Z€ [symbol] ⁶⁰.

2) Deep Multi-layer Perceptron (DMLP): The DMLP is a 12-layer DNN. For point-mass and rigid-body cases, the input is given by concatenating the obstacle representation Z, start xᵢₙᵢₜ and goal x_{goal} configurations. The configurations for the 2D point-mass robot, 3D point-mass robot, and rigid-body have dimensions 2, 3 and 3 respectively. For the Baxter robot, obstacle encoding was not included, and only the start and goal configurations were concatenated to form an input for DMLP. The dimensionality of the robot arm configuration space was 7. Each of the first nine layers is a sandwich of a linear layer, Parametric Rectified Linear Unit (PReLU) and Dropout(p). Layers one to nine transform the input vectors to 1280, 1024, 896, 768, 512, 384, 256, 256 and 128 hidden units, respectively. The tenth and eleventh layers do not use Dropout and transform the inputs to 64 and 32 units, respectively. The output layer takes the 32 units from the 11th layer and transforms them to the dimensions of the robot configuration space.

### Hyper Parameters

To train the neural models AE and DMLP, the Adagrad adaptive gradient algorithm optimizer was used with a learning rate of 0.1, where the learning rate is applies to updating weights in a neural network. A slower learning rate takes more data but tends to average its learned knowledge better over a longer period of time, whereas a fast learning rate is data-efficient but tends to forget what it learned quickly in order to adapt to new data.

The Dropout probability p and penalizing term λ were set to 0.5 and 10⁻³, respectively. To train AE, N_{obs}=30,000 different workspaces were generated randomly by the procedure described above. One of the test datasets contained the 10 workspaces which were neither seen by the AE nor by the DMLP. For the RRT* motion planner, the step size for the branching step (or tree extension) was set to 0.9 and 0.01 for the rigid body and point-mass robot case, respectively. However, for data generation on the Baxter robot, OMPL's RRT* and ROS with their default parameters setting were used.

TABLE II

| | Accuracy (%) | | |
|---|---|---|---|
| | MPNet: NR | | MPNet: HR |
| Environment | Seen-X_{obs} | Unseen-X_{obs} | Seen/Unseen-X_{obs} |
| s2D: Simple 2D | 99.3 | 98.3 | 100 |
| c2D: Complex 2D | 99.7 | 98.8 | 100 |
| c3D: Complex 3D | 99.1 | 97.7 | 100 |
| rigid: Rigid-body | 98.2 | 97.1 | 100 |

Table II summarizes the mean accuracy of MPNet with Neural-Replanning (MPNet: NR) and Hybrid-Replanning (MPNet: HR) in two test cases. The first test case includes new unseen start and goal configurations but seen obstacle positions i.e., seen-X_{obs}. The second test case corresponds to the completely new workspaces where obstacle locations were not seen by MPNet during training i.e., unseen-X_{obs}. The performance measure corresponds to the percentage of planning problems successfully solved by MPNet. Since Dropout adds stochasticity to MPNet, 20 forward passes were used through MPNet to calculate the mean performance. The mean accuracy of MPNet: HR was 100% for all test cases whereas for MPNet: NP, the mean accuracy was about 97%, and the standard deviation for all cases was roughly 0.4%.

FIGS. 15A-18B show different example scenarios where MPNet and RRT* provided successful paths. The indicated trajectories are the paths generated by MPNet and RRT*, respectively. The goal region is indicated as a small circle. The mean computational times for the MPNet and RRT* are denoted as t_{MP} and t_{R}, respectively. MPNet using the methods and systems according to present principles described was able to compute near-optimal paths for both point-mass and rigid-body robot in considerably less time than RRT*.

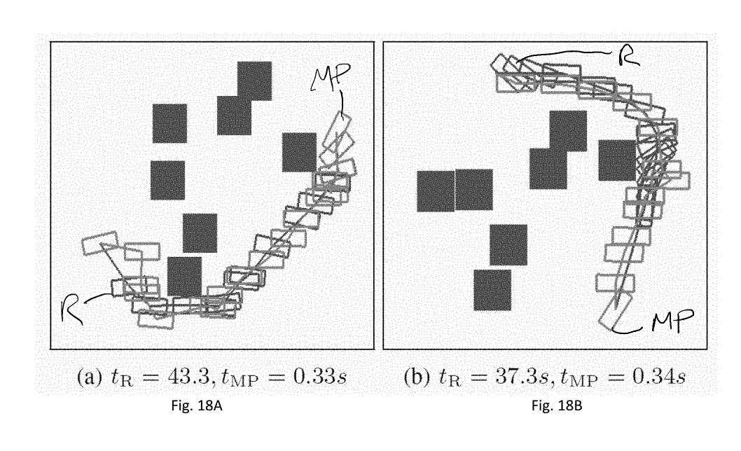

In FIGS. 15A-15B, paths are shown for simple 2D environments (s2D). In FIGS. 16A-16B, paths are shown for complex 2D environments (c2D). In FIGS. 17A-17B, paths are shown for complex 3D environments (c3D). In FIGS. 18A-18B, paths are shown for rigid body motion planning in a 2D environment (rigid).

Table III presents the time comparison of MPNet with neural replanning and hybrid replanning against state-of-the-art sampling-based motion planning methods i.e., Informed-RRT* and BIT* over the two above-mentioned test cases.

TABLE III
Time comparison of MPNet (NR: Neural Replanning; HR: Hybrid
Replanning), Informed-RRT* and BIT* on two test datasets.

| Environment | Test case | MPNet (NR) | MPNet (HR) | Informed-RRT* | BIT* | $\frac{BIT \text{:} {t}_{mean}}{MPNet ( NR ) \text{:} {t}_{mean}}$ |
|---|---|---|---|---|---|---|
| Simple 2D | Seen X_{obs} | 0.11 ± 0.037 | 0.19 ± 0.14 | 5.36 ± 0.34 | 2.71 ± 1.72 | 24.64 |
| | Unseen X_{obs} | 0.11 ± 0.038 | 0.34 ± 0.21 | 5.39 ± 0.18 | 2.63 ± 0.75 | 23.91 |
| Complex 2D | Seen X_{obs} | 0.17 ± 0.058 | 0.61 ± 0.35 | 6.18 ± 1.63 | 3.77 ± 1.62 | 22.17 |
| | Unseen X_{obs} | 0.18 ± 0.27 | 0.68 ± 0.41 | 6.31 ± 0.85 | 4.12 ± 1.99 | 22.89 |
| Complex 3D | Seen X_{obs} | 0.48 ± 0.10 | 0.34 ± 0.14 | 14.92 ± 5.39 | 8.57 ± 4.65 | 17.85 |
| | Unseen X_{obs} | 0.44 ± 0.107 | 0.55 ± 0.22 | 15.54 ± 2.25 | 8.86 ± 3.83 | 20.14 |
| Rigid | Seen X_{obs} | 0.32 ± 0.28 | 1.92 ± 1.30 | 30.25 ± 27.59 | 11.10 ± 5.59 | 34.69 |
| | Unseen X_{obs} | 0.33 ± 0.13 | 1.98 ± 1.85 | 30.38 ± 12.34 | 11.91 ± 5.34 | 36.09 |

The mean times are provided with standard deviation of all algorithms in a given problem. It can be seen that, in all test cases, the mean computation time of MPNet with neural and hybrid replanning remained around 1 second. However, the mean computation time of Informed-RRT* and BIT* increases significantly as the dimensionality of the planning problem is increased. Note that, on average, MPNet is about 40 and 20 times faster than Informed-RRT* and BIT*, respectively, in all test cases, and consistently demonstrates low computation time irrespective of the dimensionality of the planning problem.

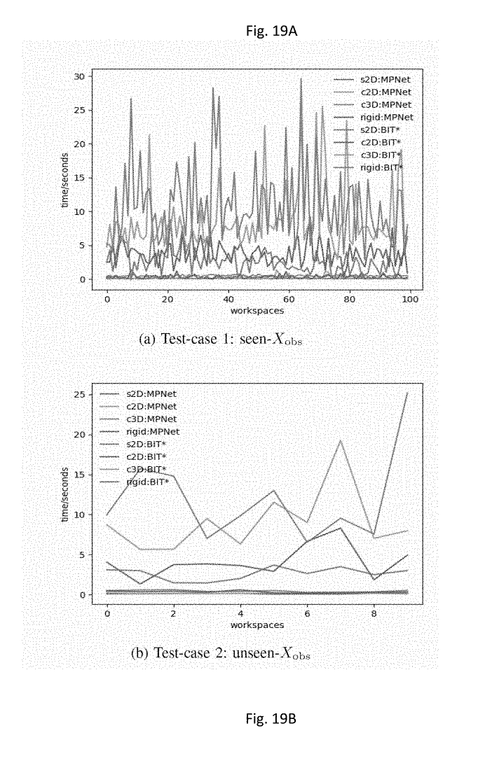

From experiments presented so far, it is evident that BIT* outperforms Informed-RRT*, therefore, in the following experiments only MPNet and BIT* were compared. FIGS. 19A and 19B compares the mean computation time of MPNet with neural replanning and BIT* in two test cases. The first test case contains 100 seen environments i.e., seen-X_{obs}, with 200 unseen start and goal configurations in each of the environments. The second test case presents the comparison of over 10 unseen environments with 2000 new start and goal configurations in each of the environments. It can be seen that the mean computation time of MPNet stays around 1 second, irrespective of the planning problem dimensionality. Furthermore, the mean computational time of BIT* not only fluctuates but also increases significantly in the rigid-body planning problem. Thus, these plots show that MPNet is more consistent and faster than RRT* in all test cases.

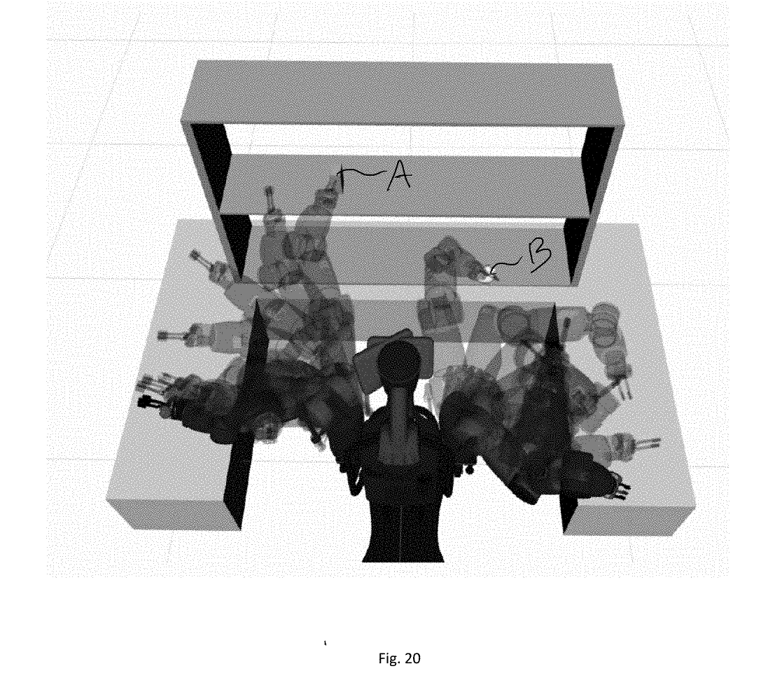

FIG. 20 shows MPNet planning motions for a dual arm 7 DOF Baxter robot for a given start and goal configuration. In FIG. 20, the robotic manipulators are at the start configurations, and the shadowed regions indicate the path followed by both manipulators to reach the target objects A and B. In this problem, MPNet and BIT* have mean computation times of 0.7 and 68.9 seconds, respectively, which makes MPNet around 100 times faster than BIT*.

The robot was required to perform a pick-place task. Systems and methods according to present principles generated the sequence of joint angles necessary for the robot arms to move towards the given object locations. A relatively small data set of 40,000 paths was generated and trained on using a model with a reduced number of layers (two and three layers with 400 units each). Due to the significantly constrained workspace in which the robot had to operate, connecting arbitrary configurations for testing did not always lead to viable paths. Even RRT-Connect, the “expert planner” used here, frequently failed to generate viable paths before timing out. Despite the lower quality data set available, utilizing the systems and methods and the measures described previously, systems and methods were able to generate smooth paths connecting the chosen configurations with mean and standard deviation of generation times as 0.56 and 0.39 seconds respectively.

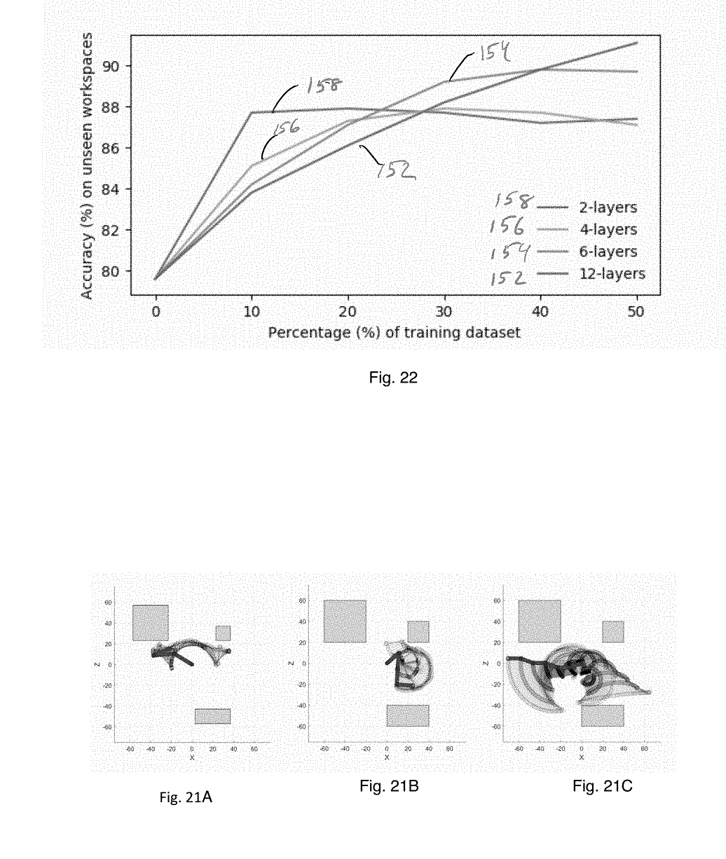

FIGS. 21A-21C show example plots of successful paths generated on 3-link, 4-link, and 6-link robots, respectively, from the left, using systems and methods according to present principles, showing the trail of the links as they make their way from an initial joint configuration.

### Stochasticity Through Dropout

A standard practice in Deep Learning is to turn off the Dropout during test time or online execution. However, for systems and methods according to present principles, Dropout is advantageous for online path generation as it has been observed that doing so significantly improves performance. Dropout is applied layer-wise to a neural network and it drops each unit in the hidden layer with a probability p€[0, 1]. The resulting neural network is a thinned network and is essentially different from the actual neural model.

Note that, in the neural replanning phase, MPNet may iterate over the non-connectable consecutive states of the coarse path to do motion planning on a finer level and thus, produces a new path. The replanning procedure is called recursively on each of its own newly-generated paths until a feasible solution is found or a loop limit is reached. Dropout adds stochasticity to the DMLP which implies that on each replanning step, the DMLP would generate different paths from previous replanning steps. This phenomenon is evident from FIG. 11 where the DMLP generated different paths for a fixed start and goal configurations. These perturbations in generated paths for fixed start and goal help in recovery from the failure. Thus, adding Dropout increases the overall performance of MPNet.

### Transfer Learning

Transfer learning allows the transfer of knowledge gained while solving one problem to a different but related problem. Neural networks are known for their catastrophic forgetting, but with newer developments, a neural network trained in one problem can be fine-tuned with a small amount of data to adapt to a new but related problem. Systems and methods described here transferred skills of MPNet trained in simple 2D cases to complex 2-D cases. FIG. 22 shows the impact of the size of the training dataset as well as the number of top training/nonfrozen layers within DMLP on the performance of DMLP in the new workspaces. In FIG. 22, the horizontal axis indicates the portion of the complex 2D training dataset used to fine tune DMLP from simple 2D cases. It can be seen that for small datasets e.g., 5%, fewer non-frozen layers gives better performance whereas for larger datasets, e.g., 40%, end-to-end training is beneficial. In other words, deeper networks, e.g., 12 layers, transfer better to new environments as the data set size increases.

### Completeness

As noted above, a coarse path may be computed by a neural network. If a coarse path is found to be not fully connectable, a replanning heuristic is executed to repair the non-connectable path segments to provide an end-to-end collision-free path. The completeness guarantees for the method depends on the underlying replanning heuristic. The classical motion planner-based replanning methods may be used to guarantee the completeness of the method according to present principles. If the classical motion planner is A*, MPNet is guaranteed to be complete. However, in the case of RRT*, systems and methods according to present principles inherent the probabilistic completeness of RRTs and RRT*, while retaining the computational gains.

### Computational Complexity

Regarding computational complexity of of systems and methods according to present principles, neural networks are known to have online execution complexity of O(1). Therefore, the execution of lines 1-2 of Algorithm 1 will have a complexity no greater than O(1). The lazy state contraction (LSC) heuristic is a simple path smoothing technique which can be executed in a fixed number of iterations as a feasible trajectory requires a finite length. Also, the LSC is not an essential but rather an optional component of the method. Its inclusion helps to generate near-optimal paths. The computational complexity of the replanning heuristic depends on the motion planner used for replanning. The two methods used for replanning are neural replanning and hybrid replanning methods. Since the neural replanner is executed for a fixed number of steps, the complexity is O(1). For the classical motion planner, RRT* is used which has O(n log n) complexity, where n is the number of samples in the tree. To reiterate, RRT* is a technique of rapidly exploring random trees, which creates samples sequentially that tend to branch out, bifurcate recursively, and create a network like a tree. Hence, for hybrid replanning, systems and methods according to present principles have a worst case complexity of O(n log n) and a best case complexity of O(1). MPNet with neural replanning is able to compute collision-free paths for more than 97% of the cases (see Table II above). Therefore, it can be said that MPNet will be operating with O(1) most of the time except for nearly 3% of the cases where the RRT* needs to be executed. Moreover, for those 3% of the cases, only a small segment of a path, given by MPNet, which does not lie in the obstacle-free space, is repaired through RRT*. This execution of RRT* on small segments of a global path reduces the complicated problem to a simple planning problem, which makes the RRT* execution computationally acceptable and practically much less than O(n log n).

What has been described is a fast and efficient neural motion planner called MPNet. MPNet includes an autoencoder that takes the point cloud of a robot's surrounding to encode the same into an invariant feature space, and a feedforward neural network that takes the environment encoding, and start and goal robotic configurations, and provides as an output a collision-free feasible path connecting the given configurations. Systems and methods according to present principles provide in certain implementations one or more of the following: (1) plan motions irrespective of obstacle(s) geometry, (2) demonstrate mean execution time of about 1 second in different 2D and 3D workspaces, (3) generalize to new unseen obstacle locations, (4) adapts very quickly with a small dataset to different working situations, e.g., from indoor living places to factory floors, and (5) have completeness guarantees.

Here it is noted that the three main qualities required of any successful motion planner are feasibility, speed, and optimality. While feasibility is usually non-negotiable, speed and optimality can often be traded for each other depending on what the priorities are. Systems and methods according to present principles achieve both high speed as well as optimality while simultaneously preserving feasibility. The experiments performed in the various environments presented cover a range of cases that support this effort. Using a discrete uniform grid to build the training set allows the estimation of the efficiency of the dataset and the generalizing ability of the network. The fact that it is possible to successfully generate paths between two continuous free floating points when it is trained only on a sparse discrete grid indicates the generalizing ability of the network. The 6-ink experiment is a good example of this. Even with just 10 uniformly spaced discrete samples per axis, the network managed to find optimal collision-free paths connecting continuous points sampled arbitrarily in the c-space.

Another effect of network size beyond the required training data directly correlates with path generation times, and increasing network size increases the path generation time at a comparable rate. While overfitting is avoided, larger networks may produce minimal performance improvements, and thus it is worth taking efforts to empirically hone it to an appropriate network size. A complementary strategy to potentially reduce network size while retaining performance and potentially improving robustness is using dropout.

A unique property of systems and methods according to present principles is with regards to realtime execution. Unlike any other motion planning strategy (with the exception of the potential field strategies, which are different in other ways), a movement can be initiated before a path through the environment is found. Because the systems and methods encode optimal behaviors, one can execute the method under the belief that any step it takes will move towards the right direction. Issues such as repair and rewiring can be resolved by considering an N-step horizon, which is a typical strategy in online motion planning and specifically replanning. Thus, in practice, one can expect that a robot can move and react instantaneously once given its goal state. The speed and invariance of performance to environments do come at a cost, namely the creation of a dataset, and time and computation power to accurately generate paths. This cost is easily accepted if the algorithm is viewed as an extremely fast way to create online optimal and feasible motion plans for any start and goal state in a static environment, given that the process of creating training data and training of the network occurs offline.

As mentioned previously, potential real-world applications of this algorithm include warehouse scenarios, robot picking and shelving, and custodial robots. Given a foundational framework for mimicking using neural networks, several extensions can be pursued. Future work can involve adapting to dynamic environments, unseen environments via transfer learning, improving sampling strategies (i.e. training data selection), and combinations of these methods, for task-based planners.

Systems and methods according to present principles scale in a manner close to linear with increases in dimensions, making the same significantly faster and more efficient for online motion planning for nontrivial problems, compared to the polynomial or worse time complexity of prior motion planners.

MPNet may be extended to dynamic environments as its great generalization to new obstacle locations makes it suitable for time-varying motion planning problems. One way of accomplishing this is by contextualizing path generation on obstacle representation in addition to the start and goal.

Another extension may be to add neural attention on the workspace encoding. For example, through unfreezing the encoder block in FIG. 11, this may be achieved without any change to MPNet, i.e., by training the MPNet end-to-end in FIG. 11, an encoder can be realized that can attend to the regions which are crucial to planning a path for any given start and goal states.

The system and method may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, other pointing device, or any other such computer input device to input data relevant to the calculations. Data may also be input by way of an inserted memory chip, hard drive, flash drives, flash memory, optical media, magnetic media, or any other type of file—storing medium. The outputs may be delivered to a user by way of a video graphics card or integrated graphics chipset coupled to a display that maybe seen by a user. Alternatively, a printer may be employed to output hard copies of the results. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or wi-fi—connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method. In the below system where motion planning is contemplated, the plural inputs may allow plural users to input relevant data at the same time.

While the invention herein disclosed is capable of obtaining the objects hereinbefore stated, it is to be understood that this disclosure is merely illustrative of the presently preferred embodiments of the invention and that no limitations are intended other than as described in the appended claims. For example, the invention can be used in a wide variety of settings, e.g., in the applications of autonomous driving, robotic surgery, aerial robotics, underwater robotics, humanoid robotics, and even space exploration.

1. An improved method of performing optimal motion path planning of a path that is both globally and locally controlled using machine learning employing a recurrent neural network, the method including offloading a portion of computation to off-line learning, comprising:
conducting an initial observation period to construct a virtual environment corresponding to an actual environment in which a robot will operate, the robot having d degrees of freedom, the virtual environment associated with a configuration space, the actual environment having actual obstacles, the obstacles represented in the configuration space by respective obstacle regions;
receiving an initial starting point and a goal point, the initial starting point and the goal point associated with respective vectors in the configuration space;
calculating a training set, the training set including a plurality of valid paths between a plurality of test starting points and a respective plurality of test ending points, and dividing each valid path into a plurality of waypoints;
using the training set to train a RNN to generate step sequences for an optimal path between the initial starting point and the goal point, the step sequences constituting sequential waypoints from the initial starting point to the goal point, and wherein the generation of each step in the step sequence takes as an input both a current predicted position and further takes as an auxiliary input the goal point.

2. The method of claim 1, wherein the training set is determined by a sample based motion planner.

3. The method of claim 2, wherein the sample based motion planner is selected from the group consisting of: A* path planning algorithm, Djikstra's algorithm, RRT, or PRM.

4. The method of claim 1, wherein the RNN is further configured to extract patterns occurring through sequences of inputs.

5. The method of claim 1, wherein the step sequences constitute sequential waypoints from the initial starting point to the goal point, and wherein the step sequences are configured to avoid the obstacle regions.

6. The method of claim 1, wherein the obstacle regions are dynamic, and further comprising performing a step of prediction, the prediction step predicting a future trajectory of the obstacle region.

7. The method of claim 1, wherein the initial starting point and the goal point are defined as a task for the robot to perform.

8. The method of claim 1, wherein if a step in a sequence is generated but is inside an obstacle region, further comprising performing a repairing strategy, wherein the repairing strategy includes randomly selecting a direction for a predetermined step distance away from a prior step, such that the predetermined step distance in the selected direction has a terminus not in the obstacle region, and then selecting the terminus as the location of a next step in the sequence, the next step directly following the prior step.

9. The method of claim 1, further comprising performing a rewiring process to potentially smooth paths by removing unnecessary nodes in the paths by evaluating if a straight trajectory connecting two nonconsecutive nodes in the path is collision free.

10. The method of claim 1, wherein the RNN is configured to retain memory of step sequences calculated previously, the memory retained in an LSTM network.

11. An improved method of performing motion path planning for a robot of a path using machine learning employing a deep feedforward neural network, comprising:
for a given workspace, performing a step of contractive autoencoding, the contractive autoencoding encoding the given workspace from a point cloud measurement, resulting in a workspace encoding;
inputting into a deep feedforward neural network the workspace encoding, and further inputting into the deep feedforward neural network a start configuration and a goal configuration; and
using the deep feedforward neural network to generate at least one end-to-end feasible motion trajectory for the robot to follow between the start configuration and the goal configuration.

12. The method of claim 11, further comprising applying learnings from the deep feedforward neural network for the given workspace to performing a step of transfer learning, such that the step of transfer learning improves an application of the deep feedforward neural network to generate at least one end-to-end feasible motion trajectory for a robot to follow in a new workspace, the improvement including that the generation of the at least one end-to-end feasible motion trajectory is performed more rapidly than without the step of transfer learning from the deep feedforward neural network.

13. The method of claim 11, wherein the generation of the at least one end-to-end feasible motion trajectory is configured or trained to predict a robot configuration at times step t+1 given the robot configuration at time t, the goal configuration, and the workspace encoding.

14. The method of claim 11, further comprising training the deep feedforward neural network using RRT*, wherein an objective for the training is to minimize a mean squared error between a predicted state and an actual state, the actual state given by the RRT*.
